(19) United States
(12) Patent Application Publication
(10) Pub. No.: US 2013/0251486 A1
(43) Pub. Date: Sep. 26, 2013

(54) LOG HANDLER

(71) Applicant: ALBERT C. POLLARD, SR., IRVINGTON, VA (US)

(72) Inventor: ALBERT C. POLLARD, SR., IRVINGTON, VA (US)

(21) Appl. No.: 13/675,043

(22) Filed: Nov. 13, 2012

Related U.S. Application Data
(60) Provisional application No. 61/685,603, filed on Mar. 21, 2012.

(51) Int. Cl. B60P 3/41

(52) U.S. Cl. CPC B60P 3/41
USPC 414/460

(57) ABSTRACT

A log handler having a front arch and a rear arch each fitted with two wheels. The arches are connected with a plurality of cross braces and parallel braces hinged at their ends in a manner to allow all four wheels to follow the surface of uneven terrain.

### CROSS REFERENCE TO RELATED APPLICATIONS

This application claims priority to U.S. Provisional Application Ser. No. 61/685,603, filed Mar. 21, 2012.

### FIELD OF INVENTION

The current invention relates to machinery used to move and manipulate logs in the timber and lumber industry. The current invention replaces the log skidder as well as serves other functions.

### BACKGROUND OF INVENTION

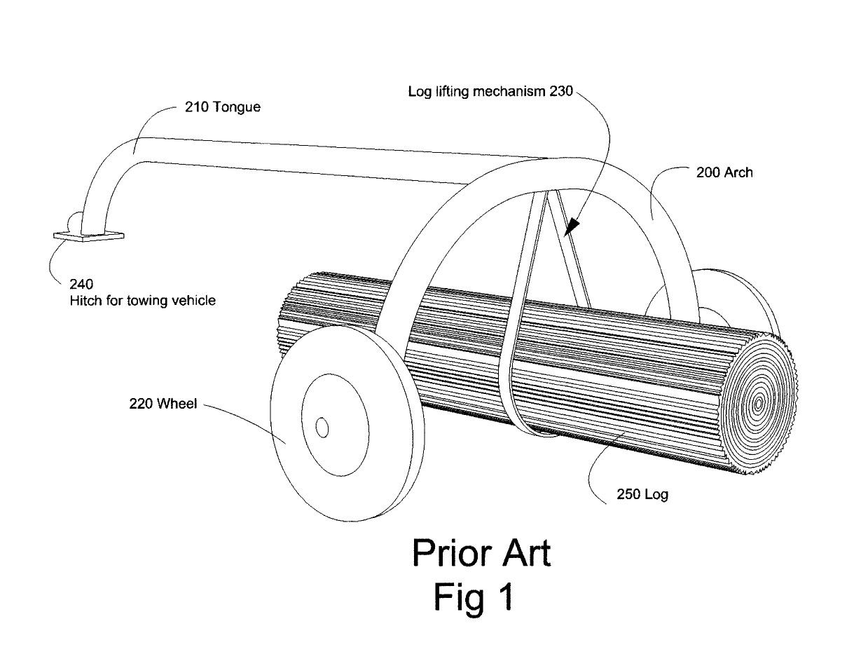

The timber industry uses a wide verity of equipment to handle logs. The equipment cost can be anywhere from a few hundreds dollars to thousands of dollars. Furthermore log-handling equipment can be self powered or pulled by a tractor or ATV. The latter category includes skidders, which are devices that pick up one end of a log and drag the log from one place to another. Also in this category are log arches with a single arch that straddles the log. FIG. 1 illustrates this prior art. An image search of the Internet revealed scores of variations of the arch shown in FIG. 1. This moving of logs is about the extent of the functionality of log skidders. After a log is move from one location to another it must be lifted onto a truck, trailer, sawmill, or whatever device is to serve the next step in processing the log. Frequently this step is facilitated by use of a tractor with a front loader or similar machine, meaning it is another piece of equipment that must be transported to the logging site. If a portable sawmill is brought to the site, the log may be place on the bed of the sawmill. By its very nature, a tractor to handle a log must be very heavy because a front loader carries the log cantilevered in front of the tractor. The tractor must be heavy enough to counterbalance the weight of the log. Also because the log is cantilevered in front of the tractor, the loader itself must be able to resist the bending moment required of it thus requiring heavy steel structural members.

The process described above not only results in the involvement of several pieces of machinery, it also results in the logs having dirt, sand and/or clay ground into the bark of the log from the skidding i.e. dragging of the log in the earth. Furthermore the earth is disturbed in the skidding operation which requires mitigation of rain runoff. Dirt ground into the bark of a log is disastrous to the blade of a sawmill. To avoid the dulling effect of the dirt on the sawmill blade a debarker is sometime used, which adds more expense to the equipment.

The current invention avoids the limitations outline above in the conventional way of handling logs. To summarize, the limitations are:

a) Use of log skidders results in dirt being ground into the bark of the log which dulls saw blades.

b) Log skidders disturb the earth requiring runoff mitigation and restoration of the work site,

c) a tractor with loaders is expensive

d) Tractors by their very nature must be heavy to handle logs.

### DRAWINGS

### Brief Description of the Drawings

FIG. 1 is prior art

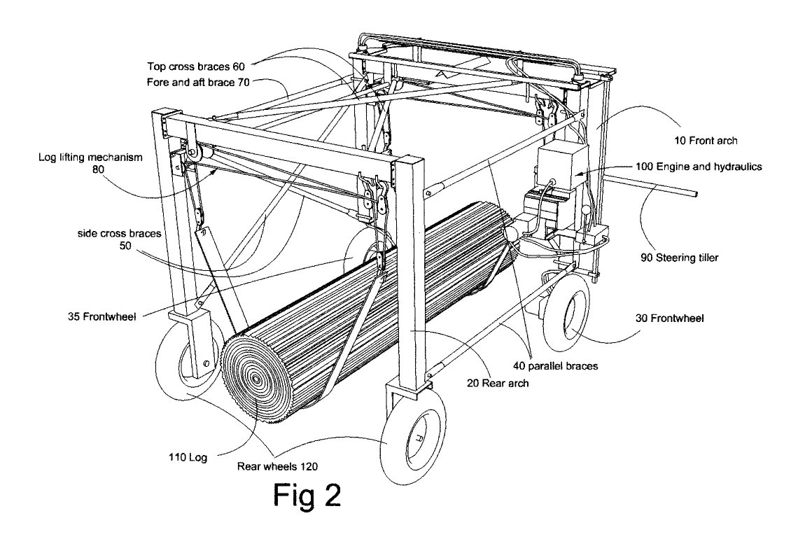

FIG. 2 is a perspective rear view of the log handler.

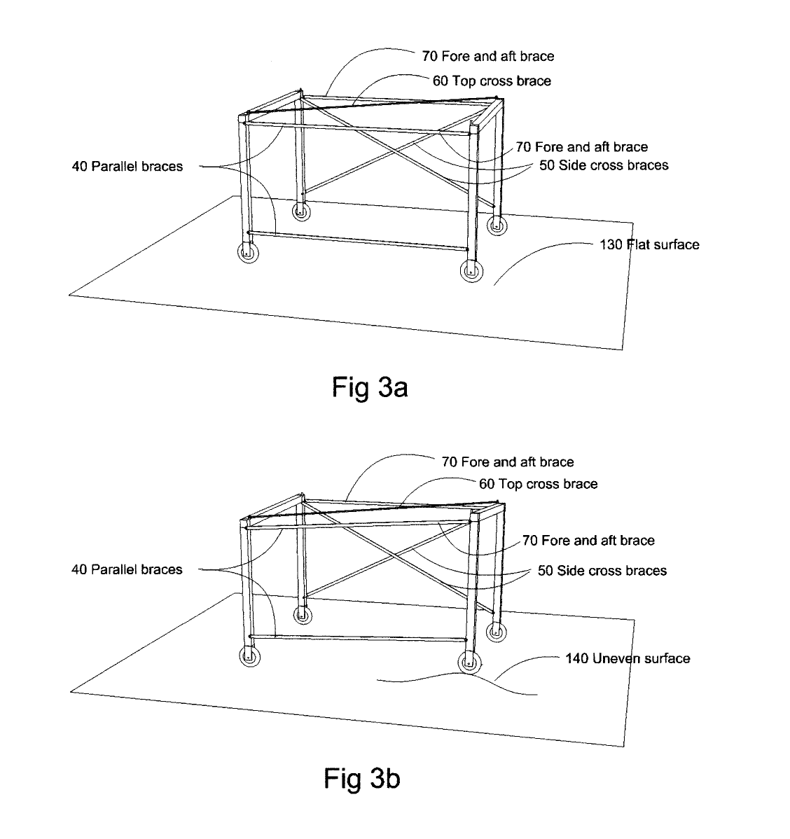

FIG. 3a and FIG. 3b schematically illustrates the bracing of the log handler on flat and uneven terrain respectively.

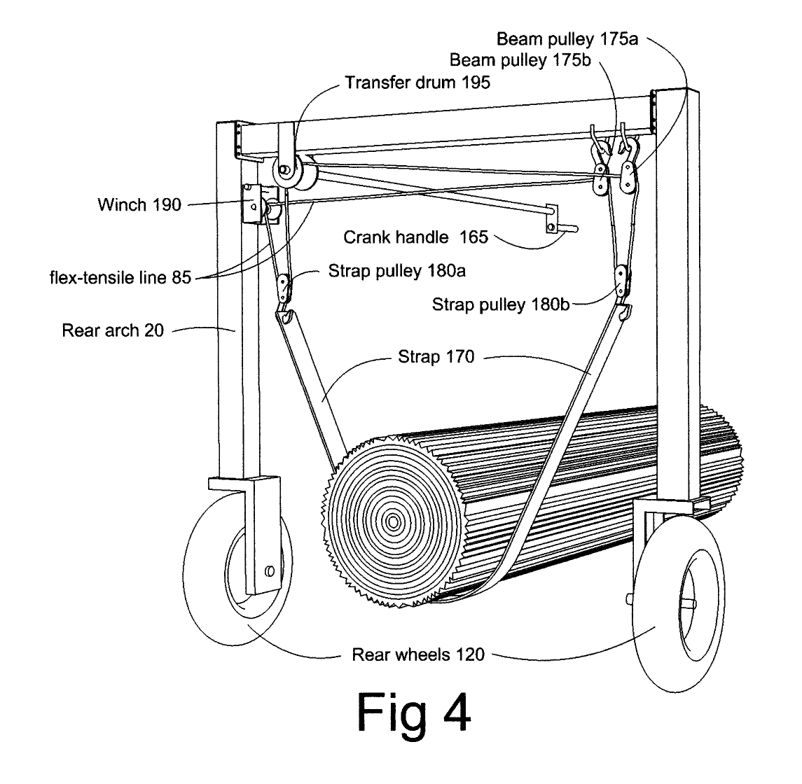

FIG. 4 illustrates the log lifting mechanism 80

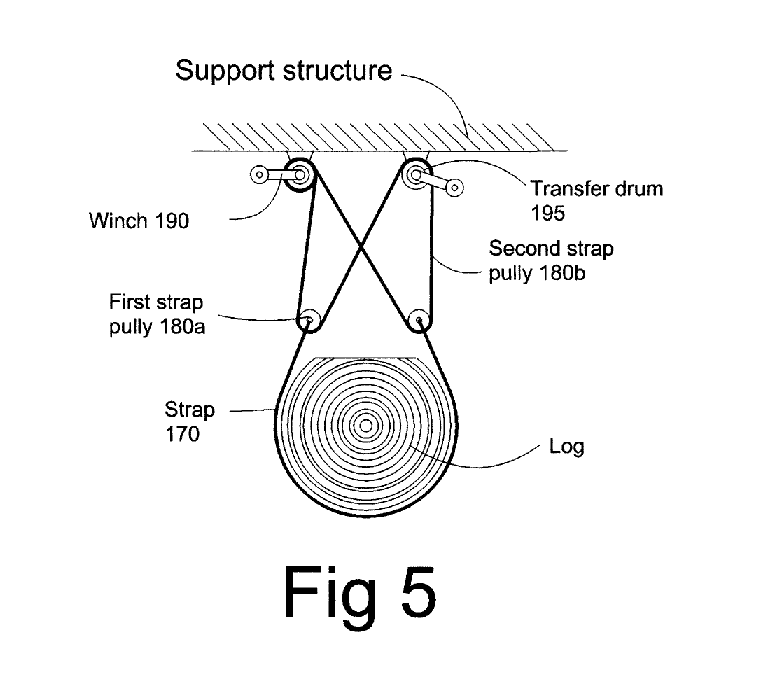

FIG. 5 illustrates an alternative log lifting mechanism

### DETAILED DESCRIPTION

Prior art is shown in FIG. 1. This prior art includes a single log arch 200 with wheels 220 at the lower extremities, a lifting mechanism 230 to lift the log 250, and a tongue 210 with a hitch 240 to attach the log arch to a towing vehicle.

The current invention uses two connected arches instead of one. The Internet search did not show a single instance of two connected log arches. Perhaps the reason for not finding prior art showing two connected arches is because nobody conceived of the method disclosed herein of connecting the two arches so that they are securely connected but also allow all four wheels of the two arches to roll over uneven terrain. A benefit of a log handling machine with two connected arches is that it can be made self propelled. A single arch log handler relies on its towing vehicle to support the tongue and thus it cannot be self-propelled.

The log handler disclosed herein can be carried on the same trailer as a portable sawmill or a load of logs because the log handler straddles the other items being carried. Frequently a logger must make two trips to the logging site, one to transport a sawmill and the other to transport a tractor. If the logs are to be brought back to a central location for processing, it still takes two trips, one to carry the logs and another to carry the tractor. In addition a second tractor loader is need to unload the trailer so that the trailer can be used to go back and fetch the first tractor. As will be seen, with the arched log carrier that is no longer necessary.

Another feature is that the log handler can easily roll a log about its longitudinal axis. The feature is used when the log handler is positioning a log on a sawmill. After the first cut is made the log is rotated 90 degrees before making the second cut.

FIG. 2 shows a perspective view of the preferred embodiment of the log handler. The log handler is comprised of a rear arch 20 resting on rear wheels 120 at the lower terminations of the arch, and a front arch 10 also resting on front wheels 30 and 35 at the lower termination of the arch. The front and rear arches are each made up of two vertical legs connected by a horizontal member at their top ends to form two rigid structural elements. In one embodiment the top horizontal member is bolted to the vertical members. This connection could be by welding or by other means, or the entire arch could be from a single piece of steel.

An engine and hydraulic system 100 applies motive force to the wheels. Hydraulic systems of this type are well known and will not be elaborated upon here.

The Steering tiller 90 has a horizontal member used by the operator to steer the log handler. The steering mechanism could be of the type invented by Ackermann in 1817. This mechanism is well known and will not be elaborated upon here.

The log handler also has a log lifting mechanism 80 and is described in a later paragraph.

Braces structurally connect the front arch 10 and rear arch 20. The braces 40, 50, 60, and 70 are designed to withstand tensile and compressive loads but not designed to withstand bending moments. Structural member designed to withstand only compressive and tensile forces can be much smaller and lighter than members that must withstand bending moments. For the purposes of this disclosure these braces with only compressive and tensile property will be referred to as compressive/tensile members. These members are connected to the front arch 10 and rear arch 20 by means of pins on the arches passing trough holes in the ends of the braces 40, 50, 60, and 70. In structural analysis this type of connection is referred to as a hinged connection. Reference to a hinged connection in this specification means this type of connection. At first glance the structure looks like the structure to hold scaffolding rigid. However there is a major difference in that scaffolding does not have the horizontal cross member connecting the tops of the diagonal cross braces. As a result scaffolding diagonal braces must be pined together at their centers to form a rigid structure when erected. Thus the diagonal compressive/tensile cross braces 40, 50, 60, and 70 of FIG. 2 could be arranges like cross braces of scaffolding and have a pin through them where they cross one another at their center. A strict application of structural analysis says the structure has become an indeterminate one because forces on the cross braces could not be determined and may be subject to bending. When large numbers of scaffolding buck are assembled, frequently a diagonal brace is used to stabilize the structure so forces are not applied to the pins of the scaffolding braces. However a careful analysis shows that in the log handler with the horizontal cross brace connecting the top ends of the diagonal cross braces, even if the cross braces were pined together there would be very little bending in the diagonal cross braces. Therefore, though not recommended, a pin through the centers of the diagonal cross braces does not have a material negative impact on the design philosophy that the cross brace members have only compressive or tensile forces.

Referring to FIGS. 3a and 3b, log handler has two sides and a top. The braces can be arranged to hold a top or side in a rectangle or in a parallelogram. Strictly speaking, rectangles and parallelograms are plane geometry figures, however as used here, the terms also include rectangles and parallelograms that have been slightly bent or warped. Thus as used here, rectangles are figures wherein opposite sides are equal and diagonals are equal before being warped. Parallelograms are figures where opposite sides are equal. Braces are the elements of the figures to hold these relationships. Observing FIG. 3a wherein the log handler is resting on a flat surface, side cross braces 50 and fore-aft brace 70 hold a side of the log handler in a rectangle. In a similar manner top cross brace 60 and fore-aft braces 70 hold the top of the log handler in a rectangle. Note one of the braces is designated as a fore-aft brace 70 as well as parallel brace 40. This is because that particular brace serves two functions. Parallel braces 40 hold a side of the log handler in a parallelogram. The side of the log handler having parallel braces 40 does not have a cross brace.

Next observe FIG. 3b showing the log handler resting on an uneven surface. The top and one side are braced in a rectangle, though the rectangles are slightly bent or warped. The opposite side is braced in a parallelogram. As can be seen from the figures, the log handler can roll over an uneven surface. Had the log handler been braced as a scaffold (that is, the top and both sides braced as rectangles), the log handler would not have been able to roll over an uneven surface as one of the wheels would leave the ground. Note that there are several configurations of braces to brace a side or top into a rectangle, including but not limited to two fore-aft braces and one diagonal brace, one fore-aft brace and two diagonal braces, and although redundant, two fore-aft braces and two diagonal braces. Also, cross brace cable in conjunction with two fore-aft braces could be used. In the case of two fore-aft braces and two diagonal braces, there must be some play at the pins where the braces are attached in order to allow the rectangle to warp. Also note the side cross braces 50 are each connected to pins on opposite sides of legs of the front arch 10 and the rear arch 20. This arrangement allows the rectangle to be warped and yet not have the side cross braces touch each other. There is only one configuration to brace into a parallelogram and that is two parallel braces. Note that in FIG. 3b the parallel braces are not parallel strictly speaking because they are part of the ‘warped’ parallelogram and are not in the same plane. However as use here, parallelogram shall mean members on opposite sides are equal.

FIG. 2 shows the overall log lifting mechanism 80. A clearer view of this mechanism is shown in FIG. 4. FIG. 4 illustrates the portion of the log lifting mechanism supported by the rear arch 20. A similar mechanism is supported by the front arch 10. The log is supported by strap 170. In turn this strap is held by the strap pulleys 180. In this disclosure the term “flex-tensile line” will be used to include any member of the group including rope, line, cable, chain, banding, cord, ribbon, strap and other linear flexible materials with tensile strength. For ease of discussion the term line is used to mean flex-tensile line. The path of the flex-tensile line 85 is from the winch 190 through a first strap pulley 180a, up to a transfer drum 195, on to a first beam pulley 175a, down to a second strap pulley 180b, back up to a second beam pulley 175b, and then back to winch 190. When the winch takes up line, it takes up line from both the first strap pulley, and the second strap pulley via the second beam pulley, As a result both ends of the strap 170 are lifted, lifting the log. If the operator wishes to roll the log, perhaps to place it on a sawmill track with a different side up, he turns the transfer drum crank handle 165. In FIG. 4 the crank handle appears on a long shaft because it is located at the front arch 10 (not shown in FIG. 4). Also not shown is an additional transfer drum located at the front arch 10. The long shaft engages both the rear arch transfer drum 195 and the front arch transfer drum (not illustrated), and rotates both transfer drums when the transfer drum crank handle is turned. Turning the crank turns the transfer drum. Turning the crank in a first direction transfers line from the first strap pulley to the second strap pulley thus rotating the log in a first direction. Turning the crank in a second direction transfers line from the second strap pulley to the first strap pulley thus rotating the log in a second direction. Note that it will take very little effort to turn the transfer drum crank handle 165 because the log is not being lifted, but merely rotated. The tension on one side of the transfer drum is balanced by tension on the other side of the drum. An identical arrangement is made on the front arch 10. None of the forces are on the braces 40, 50, 60, and 70 when the log is being rotated. The winch shown in the figures is only one arrangement to accomplish the pulling of the two ends of the line. A hydraulic cylinder, block and tackle, chain winch, or other means could be used. Whatever device is used, it is only necessary for it to be a pulling means of the flex-tensile lines. FIG. 4 shows the mechanism in its simplest form which is comprised of the following parts: a support structure supporting a means to take up line (the winch) and a transfer drum, two strap pulleys, two beam pulleys, line, and a strap configured as show in the figures. The term strap as used here may be of any flex-tensile material. A separate term ‘strap’ was used to distinguish the strap 170 from the line meaning the flex-tensile line 185.

The transfer drum 195 may take on a number of configurations. It may look like the drum of a sheet winch as used on a sailboat, it may look like the sheaves on a ratcheting pulley or it may be like the drum on a cable winch. The line if wrapped around the drum does not even have to be one continuous line, it could be two pieces of line, each terminated on the drum.

FIG. 5 illustrates an alternative log lifting mechanism that uses the minimum number of turning blocks.

Reviewing, for the purposes of this disclosure the braces with only compressive and tensile property will be referred to as compressive/tensile.

### CONCLUSIONS, RAMIFICATIONS, AND SCOPE

The above specification contains many specific descriptions so that one versed in the art could build the preferred embodiment of the log handler. However these specific descriptions should not be construed as limiting the scope of this invention. Thus, the log handler of the preferred embodiment may suggest other embodiments that fall in the scope and spirit of this disclosure, thus the scope of these embodiments should be determined by the appended claims and their legal equivalents rather than the example given.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A log handling machine for handling timber logs, the log handling machine comprising:
a front arch comprising two vertical legs with wheels at the lower extremities and a horizontal member connecting said vertical legs;
a rear arch comprising two vertical legs with wheels at the lower extremities and a horizontal member connecting said vertical legs;
members connecting said front arch and said rear arch;
a means of applying motive power to a plurality of said wheels;
a steering means; and
a means of lifting logs.

2. The log handling machine of claim 1, wherein the means of lifting logs comprises:
a strap of flex-tensile material to support a log;
first and second pulley blocks;
a transfer drum;
a pulling means; and
a turning rotating means;
wherein said strap is supported at a first end by the first pulley block and at a second end by said second pulley block;
wherein said first pulley block is threaded with a first portion of a flex-tensile line coming from said pulling means and leading to said transfer drum;
wherein said second pulley block is threaded with a second portion of a flex-tensile line, said second portion of said flex tensile line coming from said transfer drum and leading back to said pulling means;
wherein said transfer drum comprises a wheel receiving said first portion of said flex-tensile line and receiving said second portion of said flex-tensile line; and
wherein said turning rotating means rotates said wheel of said transfer drum.

3. A log handling machine for handling timber logs capable of rolling over uneven surfaces, the log handling machine comprising:
a front arch comprising a first side arch member, a second side arch member and a top arch member connecting the first and second side arch members;
a rear arch comprising a first side arch member, a second side arch member and a top arch member connecting the first and second side arch members;
wheels fitted to a lower extremity of each said side arch member;
first side compressive/tensile braces connecting each said first side arch member to form a rectangular first side of said log handling machine, such that said rectangular first side has opposite sides of fixed equal length and a diagonal of fixed length;
second side compressive/tensile braces connecting each said second side arch member to form a flexible parallelogram second side of said log handling machine, such that said parallelogram second side has opposite sides of fixed equal length and diagonals of potentially varying length; and
top arch compressive/tensile braces connecting each top member forming a rectangular top of said log handling machine such that said rectangular top has opposite sides of fixed equal length and a diagonal of fixed length.

4. The log handling machine of claim 3, further comprising a log lifting and rolling mechanism, the log lifting and rolling mechanism comprising:
a strap of flex-tensile material to support a log;
first and second pulley blocks;
a transfer drum;
a pulling means; and
a turning rotating means;
wherein said strap is supported at a first end by the first pulley block and at a second end by said second pulley block;
wherein said first pulley block is threaded with a first portion of a flex-tensile line coming from said pulling means and leading to said transfer drum;
wherein said second pulley block is threaded with a second portion of a flex-tensile line, said second portion of said flex tensile line coming from said transfer drum and leading back to said pulling means;
wherein said transfer drum comprises a wheel receiving said first portion of said flex-tensile line and receiving said second portion of said flex-tensile line; and
wherein said turning rotating means rotates said wheel of said transfer drum.

5. The log handling machine of claim 3 wherein said first side compressive/tensile braces comprise two diagonal compressive/tensile braces and one fore-aft compressive/tensile brace.

6. The log handling machine of claim 3 wherein said first side compressive/tensile braces comprise two diagonal compressive/tensile braces and two fore-aft compressive/tensile braces.

7. The log handling machine of claim 3 wherein said first side compressive/tensile braces comprise one diagonal compressive/tensile brace and two fore-aft compressive/tensile braces.

8. The log handling machine of claim 3 wherein said top compressive/tensile braces comprise one diagonal compressive/tensile brace and two fore-aft compressive/tensile braces.

9. The log handling machine of claim 3 wherein said top compressive/tensile braces comprise two diagonal compressive/tensile brace and two fore-aft compressive/tensile braces.

10. The log handling machine of claim 3 wherein said top compressive/tensile braces comprise two diagonal compressive/tensile braces and one fore-aft compressive/tensile brace.

11. The log handling machine of claim 3 wherein said second side compressive/tensile braces comprise two parallel compressive/tensile braces.

12. The log handling machine of claim 3, wherein said first side compressive/tensile braces are pivotably connected to each said first side arch member, and wherein said second side compressive/tensile braces are pivotably connected to each said second side arch member

13. The log handling machine of claim 3 wherein said top compressive/tensile braces comprise two diagonal cables and two fore-aft compressive/tensile braces.

14. The log handling machine of claim 3 wherein said top compressive/tensile braces comprise two diagonal cables and one fore-aft compressive/tensile brace.

15. A log handling machine for handling timber logs, the log handling machine comprising:
a log lifting and rolling mechanism, said log lifting and rolling mechanism comprising:
a strap of flex-tensile material to support a log;
first and second pulley blocks;
a transfer drum;
a pulling means; and
a turning rotating means;
wherein said strap is supported at a first end by the first pulley block and at a second end by said second pulley block;
wherein said first pulley block is threaded with a first portion of a flex-tensile line coming from said pulling means and leading to said transfer drum;
wherein said second pulley block is threaded with a second portion of a flex-tensile line, said second portion of said flex tensile line coming from said transfer drum and leading back to said pulling means;
wherein said transfer drum comprises a wheel receiving said first portion of said flex-tensile line and receiving said second portion of said flex-tensile line; and
wherein said turning rotating means rotates said wheel of said transfer drum.

16. The log handling machine of claim 15 wherein said pulling means comprises a winch.

17. The log handling machine of claim 15 wherein said turning rotating means comprises a crank.

18. The log handling machine of claim 15, further comprising:
third and fourth pulley blocks;
wherein said second portion of said flex tensile line coming from said transfer drum to said second pulley block is threaded through said third pulley block; and
wherein said flex tensile line leading back to said pulling means is threaded through said fourth pulley block.
